(19) United States
(12) Patent Application Publication
(10) Pub. No.: US 2015/0233683 A1
(43) Pub. Date: Aug. 20, 2015

(54) HANDGUN TARGET, TARGET SYSTEM AND METHOD OF IMPROVING SHOOTING SKILLS

(71) Applicant: James F. PHIPPS, JR., Lancaster, PA (US)

(72) Inventor: James F. PHIPPS, JR., Lancaster, PA (US)

(21) Appl. No.: 14/701,035

(22) Filed: Apr. 30, 2015

Related U.S. Application Data
(63) Continuation-in-part of application No. 13/971,008, filed on Aug. 20, 2013.
(60) Provisional application No. 61/692,301, filed on Aug. 23, 2012.

(51) Int. Cl. F41J 1/00; B42D 15/00

(52) U.S. Cl. CPC F41J 1/00; B42D 15/00

(57) ABSTRACT

A handgun target, system and method for increasing accuracy of a shooter. The handgun target includes at least one component with linear edges which is proportional to a front sight of the handgun. The linear edges converge creating precise points of reference which are configured to improve the accuracy of the shooter. The linear edges provide a linear relationship to the sight of the handgun. Wherein shots fired into the at least one component will not be visible to the shooter until the target is retrieved and shots fired which do not hit the at least one component will be visible to the shooter as the target sheet remains in position, thereby providing instantaneous visible feedback to the shooter with to allow for proper adjustment to facilitate the shooter to keep the shooter's gun, hand and trigger pull steady.

### FIELD OF THE INVENTION

The present invention is directed to a handgun target, a target system and a method of improving shooting skills which utilizes targets with linear edges.

### BACKGROUND OF THE INVENTION

While many types of shooting targets exist, targets used to improve shooting precision are often made of paper or a plastic coreflute, sometimes with a canvas or hessian back on the larger long range types. Many of these targets are a solid black circle on a white background. The black circle may have scoring rings. Targets of other shapes may be used but they are often designed based on a circular concept. One problem with circular targets is that the feedback the user/shooter receives does not readily translate into meaningful data which the user/shooter can use to improve their skills. Therefore, the round, bulls-eye targets currently being used do not help the shooter improve in an efficient or consistent manner. This is likely attributable to the limitations of a circular target's points of reference.

It would, therefore, be beneficial to provide targets which overcome the problems of the prior art and provide instant feedback to the user/shooter which allows the user/shooter to make meaningful adjustments to improve their skills.

### SUMMARY OF THE INVENTION

An object of the invention is to improve or perfect the shooting skills of a shooter using targets, a system and a method based on a linear concept, which is more easily perceived and understood by the shooter.

Another object of the invention is to improve or perfect shooting skills based on the linear relationship between the width of the gun's sight and the distance between the linear edges of the targets. This target system uses this specific relationship to perfect the shooter's sight alignment, sight picture and trigger control.

Another object of the invention is to provide targets which have linear edges or planes that converge to create a more precise point of reference versus a circular or cylindrical target which has no converging planes.

An embodiment is directed to a system of targets for increasing accuracy of a shooter of a handgun. The system includes a progressive series of target sheets to improve a shooter's sight, trigger pull and muzzle direction. Each target sheet of the progressive series of targets includes_at least one component with linear edges which is proportional to a sight of the handgun. The linear edges converge creating precise points of reference which are configured to improve the accuracy of the shooter. The linear edges provide a linear relationship to the sight of the handgun. Wherein shots fired into the at least one component will not be visible to the shooter until the target is retrieved and shots fired which do not hit the at least one component will be visible to the shooter as the target sheet remains in position, thereby providing instantaneous visible feedback to the shooter with to allow for proper adjustment to facilitate the shooter to keep the shooter's gun, hand and trigger pull steady.

An embodiment is directed to a system of handgun targets for increasing accuracy of a shooter. The system includes a progressive series of linear targets which are proportional to the width of a front sight of the handgun. The series of linear targets align with the sights of the handgun to improve a shooter's sight, trigger pull and muzzle direction. Each target of the progressive series of targets includes a first target sheet and a second target sheet. The first target sheet includes at least one first component with first vertical linear edges. The first linear edges converge to create precise points of reference which provide a linear relationship to the sights of the handgun. The second target includes at least one second component with second linear edges. The second linear edges converge to create precise points of reference which provide a linear relationship to the sights of the handgun.

An embodiment is directed to a handgun target for improving the shooter's accuracy. The handgun target includes at least one component with linear edges which is proportional to a front sight of the handgun. The linear edges converge creating precise points of reference which are configured to improve the accuracy of the shooter. The linear edges provide a linear relationship to the sight of the handgun. Wherein shots fired into the at least one component will not be visible to the shooter until the target is retrieved and shots fired which do not hit the at least one component will be visible to the shooter as the target sheet remains in position, thereby providing instantaneous visible feedback to the shooter with to allow for proper adjustment to facilitate the shooter to keep the shooter's gun, hand and trigger pull steady.

An embodiment is directed to a handgun target wherein the width of the at least one component is 1.05 inches.

An embodiment is directed to a handgun target wherein the width of the at least one component is equal to width of front sight of handgun X distance of the target from the front sight/distance of front sight from eye of user.

An embodiment is directed to a target for increasing accuracy of a shooter. The target includes at least one component with linear edges. The linear edges converge creating precise points of reference. The at least one component has a first color such that when a shot is fired through the at least one component there is no visual feedback to the shooter. The target includes a contrasting background which is provided outside of the at least one component. The contrasting background has a second color which is different from the first color, such that when a shot is fired through the contrasting background there is visual feedback to the shooter. The at least one component has linear edges, the visible feedback provides the shooter with precise instant feedback that allows for proper adjustment to continually improve accuracy by improving the relationship between the shooter's sight, trigger pull and muzzle direction.

An embodiment is also directed to a system of targets which includes at least two targets which each have at least one component with linear edges. Each of the components of these targets has a first color such that when a shot is fired through the at least one component there is no visual feedback to the shooter. In the embodiments shown and described, the components are black, but other colors can be used. Contrasting backgrounds are provided outside of the components. The contrasting backgrounds have a second color which is different from the first color, such that when a shot is fired through the contrasting backgrounds there is visual feedback to the shooter. In the embodiments shown and described, the contrasting backgrounds are white, but other colors can be used. The linear edges of the components converge creating precise points of reference. The visible feedback provides the shooter with precise instant feedback that allows for proper adjustment to continually improve accuracy.

An embodiment is also directed to a method of increasing accuracy of a shooter. The method includes: (i) providing a target having components with exclusively linear edges; (ii) the shooter aiming the a firearm at the target; (iii) the shooter firing a shot from the firearm at the target; (iv) providing no visible feedback if the shot hits the component; and (v) providing visible feedback if the shot misses the component. The visible feedback provides the shooter with precise instant feedback that allows for proper adjustment.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a view of a representative first shooting target of the present invention.

FIG. 2 is a view of a representative second shooting target of the present invention.

FIG. 3 is a view of a representative third shooting target of the present invention.

FIG. 4 is a view of a representative fourth shooting target of the present invention.

FIG. 5 is a view of a representative fifth shooting target of the present invention.

FIG. 6 is a view of a representative sixth shooting target of the present invention.

FIG. 7 is a view of a representative seventh shooting target of the present invention.

FIG. 8 is an alternate system of delivering the shooting targets of the present invention, with linear components removably adhered to a substrate.

FIG. 9 is a side view of an illustrative pistol or handgun.

FIG. 10 is a front view of an illustrative front sight of the pistol of FIG. 9.

FIG. 11 is a front view of an illustrative rear sight of the pistol of FIG. 9.

FIG. 12 is a front view of an illustrative combination of the front sight and rear sight of the pistol of FIG. 9 when the sights are properly aligned.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features; the scope of the invention being defined by the claims appended hereto.

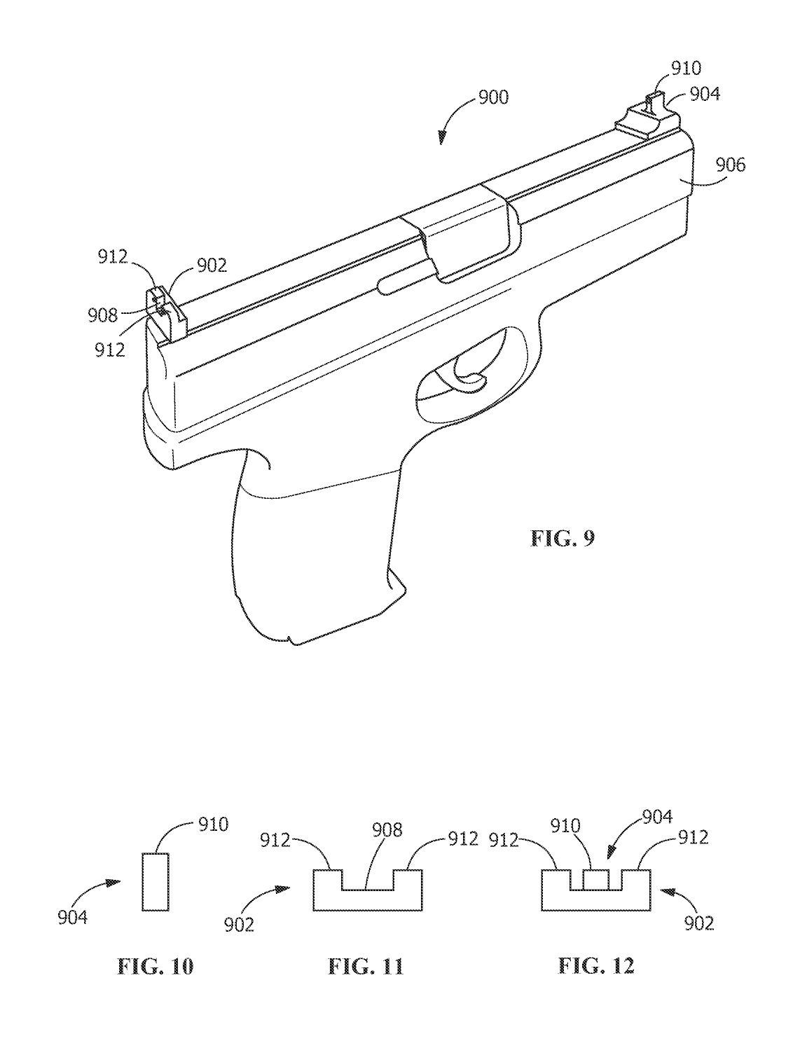

Generally, pistols or handguns 900 come with a set of open sights, a rear sight 902 and a front sight 904. The rear sight 902 is the one closest to the shooter and the front sight 904 is the one closest to the end of the barrel 906 of the pistol or handgun 900. Many of the sights are fixed sights which cannot be changed or moved. FIGS. 9 through 12 show an illustrative example of representative handgun and sights.

In order for a bullet fired from the pistol or handgun to hit the desired location or target, the shooter must aim the pistol or handgun 900 and give the barrel 906 a definite direction relative to the target. Accurate aiming is achieved when the shooter places the rear sight 902 in proper alignment with the front sight 904. This occurs when the front sight 904 is positioned in the middle of the rear sight notch 908 with equal light space on each side and the horizontal top surface 910 of the front sight 904 is positioned on the same level as the top horizontal surfaces 912 of the rear sight 902, as shown in FIG. 12. If a shooter does not observe proper aiming, the shots will not hit the intended target. Therefore, in order to perfect the shooter's ability to properly position the sights and aim the pistol or handgun, the targets, target system and method of improving or perfecting shooting skills as described herein are used.

The targets, target system and method of improving or perfecting shooting skills described herein is based on a linear relationship between the width of the pistol sight and the width between the linear edges of the target, which is more easily perceived and understood by the user/shooter. In particular, targets, target system and method of improving or perfecting shooting skills are designed to be used pistols or handguns with open sights at a distance of between 0 and 63 feet.

In contrast, many known targets for improving shooting skills are designed based on a circular concept. When used, the shooter fires rounds at the target positioned on the target sheet. After the rounds are completed, the target is retrieved and the target is scored or analyzed to provide the shooter with feedback on the shooter's accuracy. As the target are round and have not relationship to the width of the sights, the shooter cannot obtain instant feedback regarding the shooter's tendency without retrieving the target. As an example, if the shooter is pulling shots to the left of center, it is difficult for the shooter to see this tendency, as the shots are still maintained in the dark circular target. Therefore, as shots fired into the target, whether in the center or the edges of the target, are all fired through a black target with a black background, the shooter cannot see or determine the shooter's tendencies until the target is retrieved and viewed, providing no instantaneous feedback to the shooter. Consequently, when someone points their weapon at a round, bulls-eye target, the feedback the user/shooter receives does not readily translate into meaningful data which the user/shooter can use. Therefore, the round, bulls-eye targets currently being used do not help the shooter improve in an efficient or consistent manner. This is at least partially attributable to the limitations of a circular target's points of reference.

In contrast to the known art, the targets, target system and method of improving or perfecting shooting skills described herein are based on the linear relationship between the width of the gun's sight and the distance between the linear edges of the targets. As will be more fully described below, the edges of the targets have linear edges or planes that converge creating a more precise point of reference versus a circular or cylindrical target which has no converging planes. Consequently, the targets, target system and method of improving or perfecting shooting skills described herein provide instant feedback so that the user/shooter knows exactly where they are shooting. As an example, if the shooter is pulling shots to the left of center, the shots are fired outside of the dark linear target and are visible to the shooter, allowing the shooter to see this tendency. Therefore, the shooter can see or determine the shooter's tendencies without retrieving the target. This enables users/shooters to make positive adjustments to continually improve accuracy by improving the relationship between their sight, trigger pull, and muzzle direction.

As all of the targets in this system are linear, the shooter is able to easily place the front sight exactly in the same place each and every time. In addition, as will be more fully described, the targets provide proper and instantaneous feedback to help the shooter keep the gun, hand, and trigger-pull steady.

All of the components or targets described herein have a width with is in direct proportion to the size of the front sight 904. In the illustrative embodiment shown, as the size of the front sight is 0.125 in (standard size of a front sight), the width of the target is 1.05 inches. With the target spaced at 21 feet from the shooter, the front gun sight covers or is equal the size of the target. At 42 feet, the target looks half as big the front gun sight, thus increasing the amount of precision needed to hit the target. At 63 feet, the target appears the be the width of a single 9 mm round of ammunition, thereby eliminating the shooter's margin of error, requiring extreme accuracy in shooting the target. However, distances and perceptions may vary depending on the size of the front sight, the distance of the sight to the shooters eye and the distance of the eye to the target. The formula to calculate the appropriate width of the target is as follows: (width of front sight of handgun)/(the width of the target)=(distance of front sight from eye of user)/(distance of the target from the front sight). In the example described, (0.125)/(1.05)=(30 inches)/(252 inches or 21 feet).

The use of components or targets which are linear allows the shooter to easily and quickly understand his/her tendencies and correct the same. As the front and rear sight of the handgun are linear, the aiming of the handgun is facilitated by linear targets. In addition, the use of the linear targets which are proportional to the front sight of the handgun allows the shooter to easily determine tendencies without the need to retrieve the target sheet.

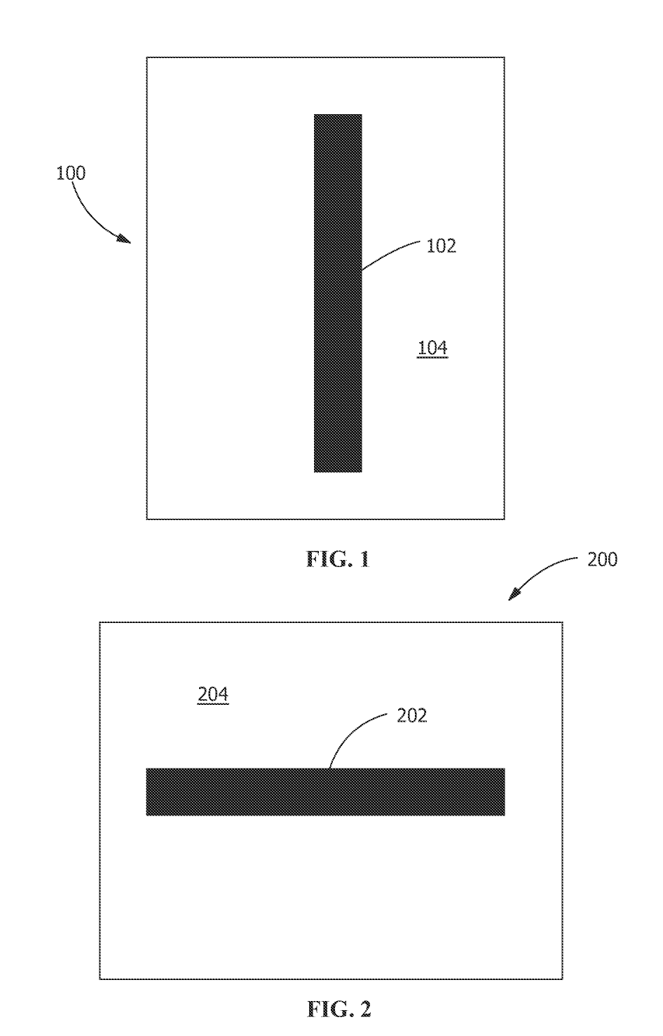

As shown in FIGS. 1 through 7, various target sheets 100, 200, 300, 400, 500, 600 and 700 with linear targets are shown for illustrative purposes. Other linear targets may be used without departing from the scope of the invention. Each target can be used individually as desired or can be used as a part of a system. In the illustrative embodiment shown and described, the system utilizes all of the linear targets described. However, other systems may be used without departing from the scope of the invention, such as but not limited, to systems which include additional linear targets, less linear targets, or any subset of the targets shown. In the illustrative embodiment, the shooter begins with target sheet 100 and progresses as each target is mastered through target sheet 700. Note that the length and configuration of the target sheet and the target components in each target sheet may vary. Factors which may influence the length and configuration of the target sheets and targets, include, but are not limited to the accuracy to be achieved, the distance the target is positioned from the shooter, as well as for many other reasons not stated herein.

Referring to FIG. 1, a first exemplary target sheet 100 is shown. The “Vertical Precision” target sheet 100 has a vertical linear component or target 102 on a contrasting background 104. The vertical linear component 102 has linear edges or sides. The vertical linear component 102 is colored such that when a shot is fired through the vertical linear component 102 there is no visual feedback to the shooter. The contrasting background 104 is colored such that when a shot is fired through the contrasting background 104 there is visual feedback to the shooter.

Stated differently, the component or target 102 is colored such that an opening created by a bullet which passes through the component or target 102 blends in with the environment in which the target sheet 100 is located, thereby making the opening essentially imperceptible to the shooter. In contrast, the background 104 of the target sheet 100 is colored to contrast with the environment such that an opening created by a bullet is visible to the shooter, thereby allowing the shooter to view and analyze his/her tendencies without retrieving the target. In the embodiment shown, the vertical linear component 102 is black and the contrasting background 104 is white, however, other colors can be used without departing from the scope of the invention.

As previously stated, the length and width of the targets and the components in each target may vary. As an example, target sheet 100 may be, but is not limited to, approximately 10.5 inches by approximately 10.5inches, with a component or target 102 which measures approximately 6 inches by approximately 1.05 inch.

In use, the shooter aims at the vertical linear component 102. If the shot hits the vertical linear component 102, there is no instantaneous feedback, as the opening/hole generated by the shot will reside in the black area (in the illustrative embodiment shown) providing no instantaneous visual feedback to the shooter, as the opening cannot be easily viewed by the shooter until the target sheet 100 is retrieved. If the shot misses the vertical linear component 102 (typically to the left or right of the vertical linear component 102), the shooter gets precise instant feedback without the need to retrieve the target sheet 100. As the opening generated by the errant shot generates an opening/hole through the contrasting background 104, the opening/hole is instantaneously visible to the shooter, providing immediate feedback that the shooter has missed the target, allowing the shooter to understand and correct his/her tendencies as the shooter continues his/her rounds. The objective of target sheet 100 is to provide vertical precision, improving or perfecting the shooter's ability to keep the gun from waving from side to side as the trigger is pulled (vertical hold). This target sheet 100 primarily provides feedback regarding shots which are offline to either the left or right of the target, thereby providing feedback to the shooter regarding the shooter's grip, trigger-pull, and muzzle. The continued use of this target sheet 100 improves the shooter's wavering and control of the firearm in the horizontal direction (i.e. vertical hold).

Referring to FIG. 2, a second exemplary target sheet 200 is shown. “Horizontal Precision” target sheet 200 has a horizontal linear component 202 on a contrasting background 204. The horizontal linear component 202 has linear edges or sides. The horizontal linear component 202 is colored such that when a shot is fired through the horizontal linear component 202 there is no visual feedback to the shooter. The contrasting background 204 is colored such that when a shot is fired through the contrasting background 204 there is visual feedback to the shooter.

Stated differently, the component or target 202 is colored such that an opening created by a bullet which passes through the component or target 202 blends in with the environment in which the target sheet 200 is located, thereby making the opening essentially imperceptible to the shooter. In contrast, the background 204 of the target sheet 200 is colored to contrast with the environment such that an opening created by a bullet is visible to the shooter, thereby allowing the shooter to view and analyze his/her tendencies without retrieving the target. In the embodiment shown, the horizontal linear component 202 is black and the contrasting background 204 is white, however, other colors can be used without departing from the scope of the invention. In the embodiment shown, the horizontal linear component 202 is similar to the vertical linear component 102, with the exception that the horizontal linear component 202 is rotated ninety degrees relative to the vertical linear component 102.

As previously stated, the length and width of the targets and the components in each target may vary. As an example, target sheet 200 may be, but is not limited to, approximately 10.5 inches by approximately 10.5 inches, with a component 202 which measures approximately 1.05 inch by approximately 6 inches.

In use, the shooter aims at the horizontal linear component 202. If the shot hits the horizontal linear component 202, there is no instantaneous feedback, as the opening/hole generated by the shot will reside in the black area (in the illustrative embodiment shown) providing no visual instantaneous feedback to the shooter, as the opening cannot be easily viewed by the shooter until the target sheet 200 is retrieved. If the shot misses the horizontal linear component 202 (typically to the top or bottom of the horizontal linear component 202), the shooter gets precise instant feedback that allows for proper adjustment. As the opening generated by the errant shot generates an opening/hole through the contrasting background 204, the opening/hole is instantaneously visible to the shooter, providing immediate feedback that the shooter has missed the target, allowing the shooter to understand and correct his/her tendencies as the shooter continues his/her rounds. The objective of target sheet 200 is to provide horizontal precision, improving or perfecting the shooter's ability to keep the gun from moving up or down due to excess trigger pull or a short post shot follow through. This target sheet 200 primarily provides feedback regarding shots which are offline either above or below the target, thereby providing feedback to the shooter regarding the shooter's grip, trigger-pull, and muzzle. The continued use of this target sheet 200 improves the shooter's wavering and control of the firearm in the vertical direction, allowing the shooter to master keeping the muzzle of the gun from moving up or down as the trigger is pulled (i.e. horizontal hold).

In one illustrative sequence or system the “Horizontal Precision” target sheet 200 is used after the shooter has mastered target sheet 100 and control of the firearm in the horizontal direction.

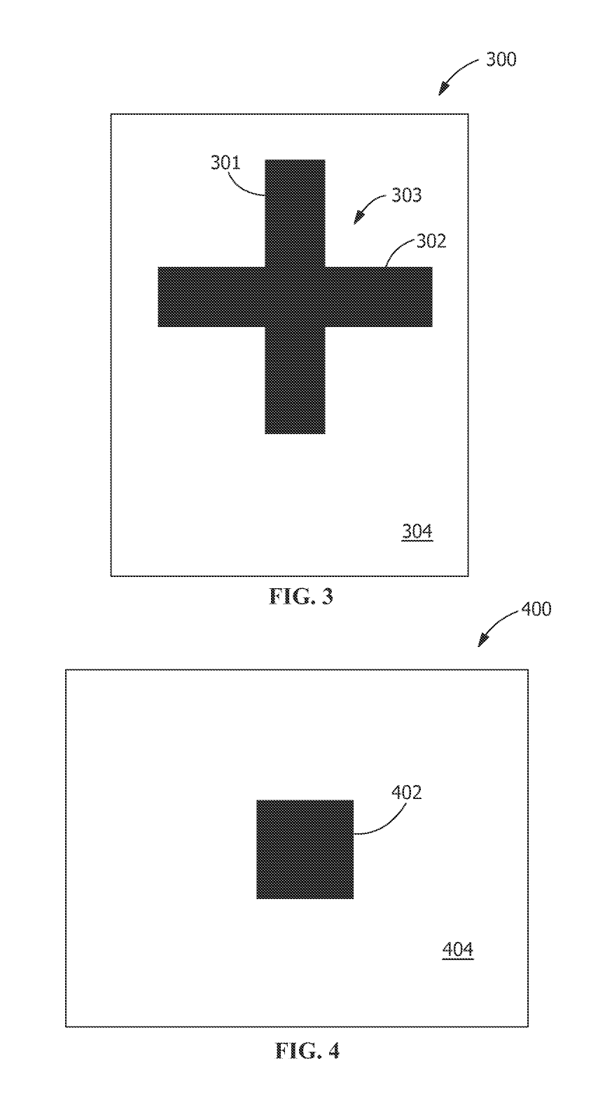

Referring to FIG. 3, a third exemplary target sheet 300 is shown. The “Calibration Precision” target sheet 300 has a vertical linear component 301 and a horizontal linear component 302 which forms a cross component or target 303 on a contrasting background 104. The cross component 303, including the vertical linear component 301 and the horizontal linear component 302 have linear edges or sides. The cross component 303 is colored such that when a shot is fired through the cross component 303 there is no visual feedback to the shooter. The contrasting background 304 is colored such that when a shot is fired through the contrasting background 304 there is visual feedback to the shooter.

Stated differently, the component or target 303 is colored such that an opening created by a bullet which passes through the component or target 303 blends in with the environment in which the target sheet 300 is located, thereby making the opening essentially imperceptible to the shooter. In contrast, the background 304 of the target sheet 300 is colored to contrast with the environment such that an opening created by a bullet is visible to the shooter, thereby allowing the shooter to view and analyze his/her tendencies without retrieving the target. In the embodiment shown, the cross component 303 is black and the contrasting background 304 is white, however, other colors can be used without departing from the scope of the invention.

As previously stated, the length and width of the targets and the components in each target may vary. As an example, target sheet 300 may be, but is not limited to, approximately 10.5 inches by approximately 10.5 inches, with a component 301 which measures approximately 6 inches by approximately 1 inch and a component 302 which measures approximately 1 inch by approximately 6 inches.

In use, the shooter aims at the cross component 303. If the shot hits the cross component 303, there is no instantaneous feedback, as the opening/hole generated by the shot will reside in the black area (in the illustrative embodiment shown) providing no visual feedback to the shooter, as the opening cannot be easily viewed by the shooter until the target sheet 300 is retrieved. If the shot misses the cross component 303, the shooter gets precise instant feedback that allows for proper adjustment. As the opening generated by the errant shot generates an opening/hole through the contrasting background 304, the opening/hole is instantaneously visible to the shooter, providing immediate feedback that the shooter has missed the target, allowing the shooter to understand and correct his/her tendencies as the shooter continues his/her rounds. The objective of target sheet 300 is to help the shooter learn how to focus on, take out, or “erase” the middle of this target, which is the intersection of both components 301 and 302, thereby improving calibration precision. This target sheet 300 primarily provides feedback regarding which plane the gun is being consistently pointed.

In one illustrative sequence or system the “Calibration Precision” target sheet 300 is used after the shooter has mastered target sheet 100, control of the firearm in the horizontal direction and target sheet 200, and control of the firearm in the vertical direction, thereby allowing the shooter to combine both vertical and horizontal planes focusing on shooting the middle of the cross.

Referring to FIG. 4, a fourth exemplary target sheet 400 is shown. The “Placement Precision” target sheet 400 is a small solid box component 402 having linear edges or sides on a contrasting background 404. The solid box component 402 is colored such that when a shot is fired through the solid box component 402 there is no visual feedback to the shooter. The contrasting background 404 is colored such that when a shot is fired through the contrasting background 404 there is visual feedback to the shooter.

Stated differently, the component or target 402 is colored such that an opening created by a bullet which passes through the component or target 402 blends in with the environment in which the target sheet 400 is located, thereby making the opening essentially imperceptible to the shooter. In contrast, the background 404 of the target sheet 400 is colored to contrast with the environment such that an opening created by a bullet is visible to the shooter, thereby allowing the shooter to view and analyze his/her tendencies without retrieving the target. In the embodiment shown, the solid box component 402 is black and the contrasting background 404 is white, however, other colors can be used without departing from the scope of the invention.

As previously stated, the length and width of the targets and the components in each target may vary. As an example, target sheet 400 may be, but is not limited to, approximately 10.5 inches by approximately 10.5 inches, with a component 402 which measures approximately 2 inches by approximately 2 inches.

In use, the shooter aims at the solid box component 402. If the shot hits the solid box component 402, there is no instantaneous feedback, as the opening/hole generated by the shot will reside in the black area (in the illustrative embodiment shown) providing no visual feedback to the shooter, as the opening cannot be easily viewed by the shooter until the target sheet 400 is retrieved. If the shot misses the solid box component 402, the shooter gets, precise instant feedback that allows for proper adjustment. As the opening generated by the errant shot generates an opening/hole through the contrasting background 404, the opening/hole is instantaneously visible to the shooter, providing immediate feedback that the shooter has missed the target, allowing the shooter to understand and correct his/her tendencies as the shooter continues his/her rounds. The objective of target sheet 400 is to place all of the rounds inside of the black box, thereby improving placement precision. This target sheet 400 has more area for feedback than the previously described targets and is designed to teach the shooter how to shoot in tight groups.

In one illustrative sequence or system the “Placement Precision” target sheet 400 is used after the shooter has mastered targets 100, 200 and 300. Target sheet 400 is a more advanced target of the target system. The objective of the advanced targets of this system is to more precisely improve the shooters grip, muzzle pointing, and trigger pull while reducing the size of the desired target area.

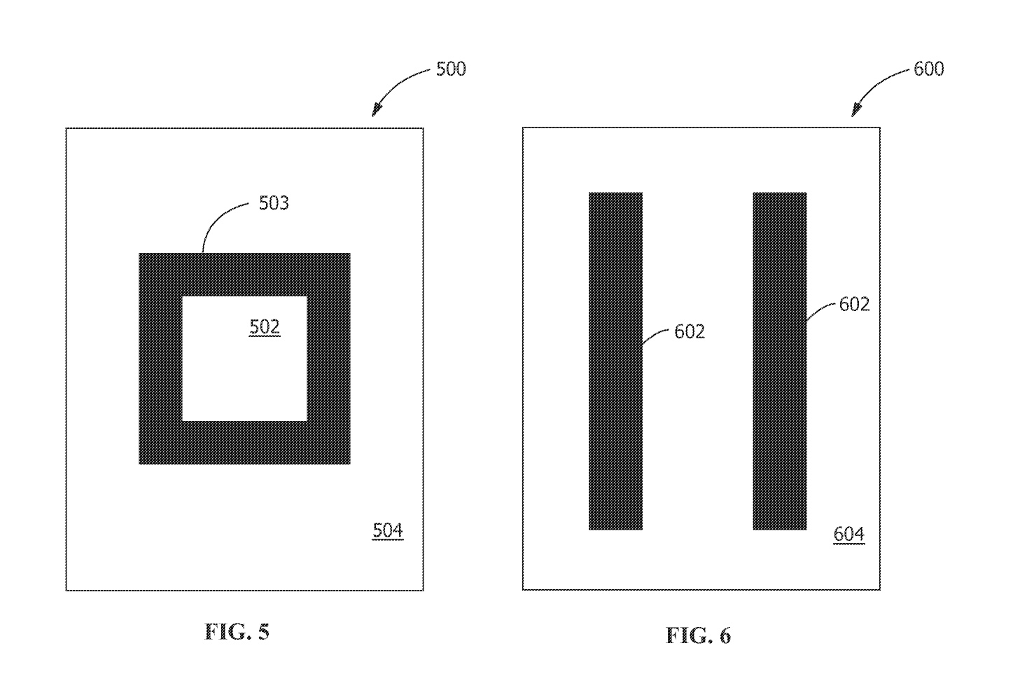

Referring to FIG. 5, a fifth exemplary target sheet 500 is shown. The “Draw Placement” target sheet 500 is a box component 502 which is larger than the box component 402 of FIG. 4. The box component 502 has linear edges or sides and is surrounded by a linear solid outline component 503. The solid outline component 503 is positioned on a contrasting background 504. The solid outline component 503 has linear edges or sides. The solid outline component 503 is colored such that when a shot is fired through the solid outline component 503 there is no visual feedback to the shooter. The box component 502 and the contrasting background 504 are colored such that when a shot is fired through the box component 502 or the contrasting background 504 there is visual feedback to the shooter.

Stated differently, the component or target 503 is colored such that an opening created by a bullet which passes through the component or target 503 blends in with the environment in which the target sheet 500 is located, thereby making the opening essentially imperceptible to the shooter. In contrast, the background 504 and the box component 502 of the target sheet 500 are colored to contrast with the environment such that an opening created by a bullet is visible to the shooter, thereby allowing the shooter to view and analyze his/her tendencies without retrieving the target. In the embodiment shown, the solid outline component 503 is black and box component 502 and the contrasting background 504 is white, however, other colors can be used without departing from the scope of the invention.

As previously stated, the length and width of the targets and the components in each target may vary. As an example, target sheet 500 may be, but is not limited to, approximately 10.5 inches by approximately 10.5 inches, with a component 502 which measures approximately 3 inches by approximately 3 inches and a component 503 which outside edges measure approximately 5 inches by approximately 5 inches.

In use, the shooter aims at the box component 502. In contrast to the previous targets, if the shot hits the box component 502, the shooter gets, instant feedback. As the opening generated by the shot generates an opening/hole through the contrasting box component 502, the opening/hole is instantaneously visible to the shooter, providing immediate feedback that the shooter has hit the target. Similarly, if the shot misses the box component 502 and the solid outline component 503, the shooter gets precise instant feedback that allows for proper adjustment. As the opening generated by the errant shot generates an opening/hole through the contrasting background 504, the opening/hole is instantaneously visible to the shooter, providing immediate feedback that the shooter has missed the target, allowing the shooter to understand and correct his/her tendencies as the shooter continues his/her rounds.

If the shot hits the solid outline component 503, the opening/hole generated by the shot will reside in the black area (in the illustrative embodiment shown) providing no instantaneous visual feedback to the shooter that the box has been hit, as the opening cannot be easily viewed by the shooter until the target sheet 500 is retrieved. While the primary objective of this target sheet 500 is to hit the box component 502, it is acceptable to shoot the solid outline component 503 as the shooter works towards honing their precision.

In one illustrative sequence or system the “Draw Placement” target sheet 500 is used after the shooter has mastered targets 100, 200, 300 and 400. Target sheet 500 is designed for use from the draw, low-ready, or surrender position to improve a shooter's draw precision so that the shooter can hit the target while moving the gun to acquire a target. Target sheet 500 is an advanced target of the target system and is a more advanced target compared to target sheet 400. The larger design allows the shooter to improve their skills starting from a non target acquired position. Target sheet 500 can be used for shooting for points and is designed for competition with other shooters (however it does not have to be used in this manner).

Referring to FIG. 6, a sixth exemplary target sheet 600 is shown. The “Re-Acquisition Precision” target sheet 600 is two vertical linear components 602 in a row on a contrasting background 604. The vertical linear components 602 have linear edges or sides. The vertical components 602 are colored such that when a shot is fired through the vertical components 602 there is no visual feedback to the shooter. The contrasting background 604 is colored such that when a shot is fired through the contrasting background 604 there is visual feedback to the shooter.

Stated differently, the component or target 602 is colored such that an opening created by a bullet which passes through the component or target 602 blends in with the environment in which the target sheet 600 is located, thereby making the opening essentially imperceptible to the shooter. In contrast, the background 604 of the target sheet 600 is colored to contrast with the environment such that an opening created by a bullet is visible to the shooter, thereby allowing the shooter to view and analyze his/her tendencies without retrieving the target. In the embodiment shown, the vertical components 602 are black and the contrasting background 604 is white, however, other colors can be used without departing from the scope of the invention.

As previously stated, the length and width of the targets and the components in each target may vary. As an example, target sheet 600 may be, but is not limited to, approximately 10.5 inches by approximately 10.5 inches, with components 602 which each measures approximately 6 inches by approximately 1.05 inch.

In use, the shooter aims at the vertical components 602. If the shot hits one of the vertical components 602, there is no instantaneous feedback, as the opening/hole generated by the shot will reside in the black area (in the illustrative embodiment shown) providing no visual feedback to the shooter, as the opening cannot be easily viewed by the shooter until the target sheet 100 is retrieved. If the shot misses either of the vertical components 602, the shooter gets precise instant feedback that allows for proper adjustment. As the opening generated by the errant shot generates an opening/hole through the contrasting background 604, the opening/hole is instantaneously visible to the shooter, providing immediate feedback that the shooter has missed the target, allowing the shooter to understand and correct his/her tendencies as the shooter continues his/her rounds. The objective of target sheet 600 is the re-acquisition precision of multiple targets in rapid succession. This is achieved by firing multiple alternating shoots at each of the vertical components 602. Adding/limiting the time to fire the multiple shoots will further improve a shooter's grip, muzzle pointing, and trigger pull while moving.

Target sheet 600 can also be rotated clockwise showing horizontal linear components instead of vertical linear components. This rotation increases the difficulty of the target, but further advancing the skills of the shooter.

In one illustrative sequence or system the “Re-Acquisition Precision” target sheet 600 is used after the shooter has mastered targets 100, 200, 300, 400 and 500. Target sheet 600 is a more advanced target of the target system. The objective of this advanced target to allow the shooter to quantify shooting accuracy under pressure(time). This is in contrast to targets 100 and 200, which are not timed and which teach the shooter to hold a weapon steady while pulling the trigger and mastering to hit a single line.

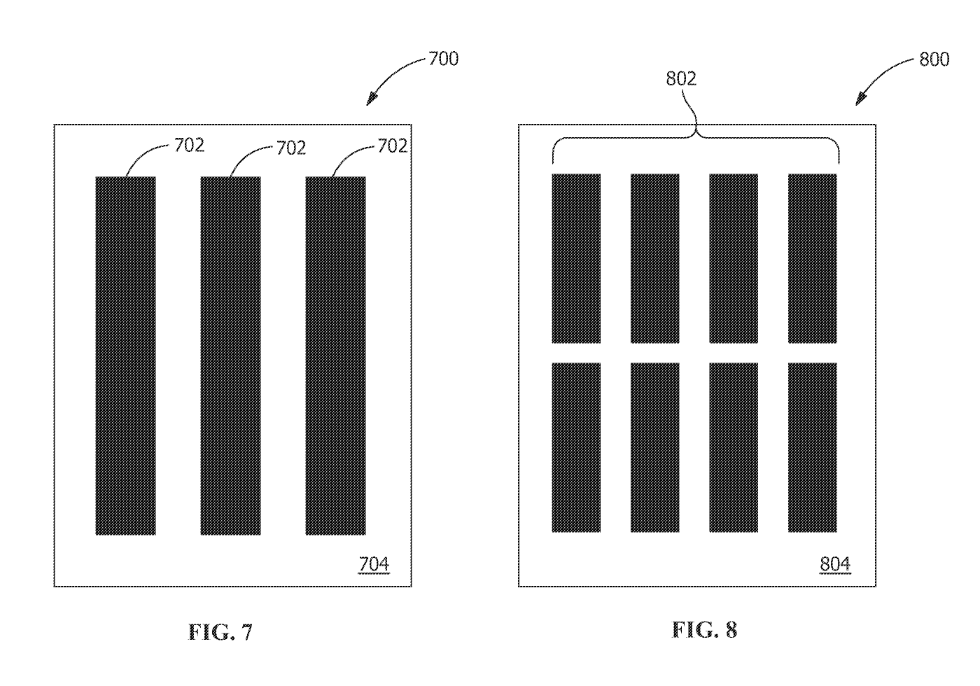

Referring to FIG. 7, a seventh exemplary target sheet 700 is shown. The “Multiple Acquisition Precision” target sheet 700 is three vertical linear components 702 in a row on a contrasting background 704. The vertical linear components 702 have linear edges or sides. The vertical components 702 are colored such that when a shot is fired through the vertical components 702 there is no visual feedback to the shooter. The contrasting background 704 is colored such that when a shot is fired through the contrasting background 704 there is visual feedback to the shooter.

Stated differently, the component or target 702 is colored such that an opening created by a bullet which passes through the component or target 702 blends in with the environment in which the target sheet 700 is located, thereby making the opening essentially imperceptible to the shooter. In contrast, the background 704 of the target sheet 700 is colored to contrast with the environment such that an opening created by a bullet is visible to the shooter, thereby allowing the shooter to view and analyze his/her tendencies without retrieving the target. In the embodiment shown, the vertical components 702 are black and the contrasting background 704 is white, however, other colors can be used without departing from the scope of the invention.

As previously stated, the length and width of the targets and the components in each target may vary. As an example, target sheet 700 may be, but is not limited to, approximately 10.5 inches by approximately 10.5 inches, with components 702 which each measures approximately 6 inches by approximately 1 inch.

In use, the shooter aims at the vertical components 702. If the shot hits one of the vertical components 702, there is no instantaneous feedback, as the opening/hole generated by the shot will reside in the black area (in the illustrative embodiment shown) providing no visual feedback to the shooter, as the opening cannot be easily viewed by the shooter until the target sheet 100 is retrieved. If the shot misses all of the vertical components 702, the shooter gets precise instant feedback that allows for proper adjustment. As the opening generated by the errant shot generates an opening/hole through the contrasting background 704, the opening/hole is instantaneously visible to the shooter, providing immediate feedback that the shooter has missed the target, allowing the shooter to understand and correct his/her tendencies as the shooter continues his/her rounds. The objective of target sheet 700 is the re-acquisition of multiple targets in rapid succession. This is achieved by firing multiple alternating shoots at each of the vertical components 702. Adding/limiting the time to fire the multiple shoots will further improve a shooter's grip, muzzle pointing, and trigger pull while moving.

Target sheet 700 can also be rotated clockwise showing horizontal linear components instead of vertical linear components. This rotation increases the difficulty of the target, but further advancing the skills of the shooter.

In one illustrative sequence or system the “Re-Acquisition Precision” target sheet 700 is used after the shooter has mastered targets 100, 200, 300, 400, 500 and 600. Target sheet 700 is a more advanced target of the target system. The objective of this advanced target to allow the shooter to quantify shooting accuracy under pressure(time). Target sheet 700 introduces a third linear component to improve a shooter's multiple acquisition precision in moving their gun between three positions while continuing to improve a shooter's grip, muzzle pointing, and trigger pull. Target sheet 700 teaches the shooter the same skill as target sheet 600, but it is more advanced due to the addition of the third component.

Referring to FIG. 8, an alternate system of delivering the targets is shown. In this embodiment, linear components 802 are provided on a substrate 804. The linear components 802 may be similar in size or may be varied in size. The arrangement and orientation of the components 802 on the substrate 804 may also be varied. Each of the linear components 802 has linear edges or sides. The linear components 802 are removably adhered to the substrate 804 whereby the linear components 802 can be removed from the substrate 804 and positioned on a second substrate to create a target on the second substrate.

The linear components 802 may be made or cut from plastic, paper, or other materials which provide the structural integrity required to maintain the integrity and shape of the linear components when they are transferred from the first substrate 804 to the second substrate. The material of the linear components 802 must also allow for shots to penetrate therethrough. The substrate 804 may be plastic, paper, or other materials which provide the structural integrity required to maintain the integrity of the linear components 802 when the linear components 802 and substrate 804 are transported. The substrate 804 and the linear components 802 may be made from the same material or different materials. The linear components 802 are adhered to the substrate 804 by means of tape, adhesive, Velcro, or other types of devices which allow the linear components 802 to be removed from the substrate 804 and adhered to a second substrate.

The length and width of the substrate and the components may vary. As an example, substrate 804 may be, but is not limited to, approximately 10.5 inches by approximately 10.5 inches, with components 802 which each measures approximately 5 inches by approximately 1 inch.

In use, at least one linear component or target 802 is removed from the substrate 804 and positioned on a second substrate. If multiple linear components 802 are removed from the substrate and positioned on the second substrate, the multiple linear components 802 may be arranged in the any pattern desired by the user. In the embodiment shown, the linear components 802 are colored such that when a shot is fired through the linear components 802 there is no instantaneous visual feedback to the shooter, as the opening cannot be easily viewed by the shooter until the target sheet 100 is retrieved. The contrasting background of the second substrate is colored such that when a shot is fired through the contrasting background there is visual feedback to the shooter, allowing the shooter to understand and correct his/her tendencies as the shooter continues his/her rounds. In the embodiment shown, the vertical linear component 802 is black and the contrasting background is white, however, other colors can be used without departing from the scope of the invention.

The linear components 802 may be positioned in various configurations, including, but not limited to the configurations shown in FIGS. 1 through 7. If the linear components 802 are arranged in one of the respective patterns described above, the resulting target would have the same characteristics as the respective pattern. Alternatively, if the linear components 802 are arranged in patterns not described above, the linear edges or planes of the components 802 still converge to create a more precise point of reference versus a circular or cylindrical target which has no converging planes. Consequently, regardless of the pattern of a particular target, the targets, target system and method of improving or perfecting shooting skills described herein provide instant feedback so that the user/shooter knows exactly where they are shooting, allowing users/shooters to make positive adjustments to continually improve accuracy by improving the relationship between their sight, trigger pull, and muzzle direction. As all of the targets in this system are created using linear components, the shooter is able to easily place the front sight exactly in the same place each and every time. In addition, as previously described, the targets provide proper and instantaneous feedback to help the shooter keep the gun, hand, and trigger-pull steady.

As previously described, the individual targets may be combined to create a system of targets which is used to increase the accuracy of a shooter. The system includes at least two targets which may include the targets described above or other targets which have at least one component with linear edges. Each of the components of these targets has a first color such that when a shot is fired through the at least one component there is no visual feedback to the shooter. In the embodiments shown and described, the components are black, but other colors can be used. Contrasting backgrounds are provided outside of the components. The contrasting backgrounds have a second color which is different from the first color, such that when a shot is fired through the contrasting backgrounds there is visual feedback to the shooter. In the embodiments shown and described, the contrasting backgrounds are white, but other colors can be used. The linear edges of the components converge creating precise points of reference. The visible feedback provides the shooter with precise instant feedback that allows for proper adjustment to continually improve accuracy.

The targets and system utilize a unique method of increasing accuracy of a shooter. The method includes: (i) providing a target having components with exclusively linear edges; (ii) the shooter aiming the a firearm at the target; (iii) the shooter firing a shot from the firearm at the target; (iv) providing no visible feedback if the shot hits the component; and (v) providing visible feedback if the shot misses the component. The visible feedback provides the shooter with precise instant feedback that allows for proper adjustment.

The use of linear targets which are proportional to the sight of the handgun or pistol allows the targets and target system to be used as a training tool to allow the shooter to more readily identify and correct improper tendencies.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A system of targets for increasing accuracy of a shooter of a handgun, the system comprising:
a progressive series of target sheets to improve a shooter's sight, trigger pull and muzzle direction, each target sheet of the progressive series of targets comprising;
at least one component with linear edges which is proportional to a sight of the handgun, the linear edges converge creating precise points of reference which are configured to improve the accuracy of the shooter, the linear edges provide a linear relationship to the sight of the handgun,
wherein shots fired into the at least one component will not be visible to the shooter until the target is retrieved and shots fired which do not hit the at least one component will be visible to the shooter as the target sheet remains in position, thereby providing instantaneous visible feedback to the shooter with to allow for proper adjustment to facilitate the shooter to keep the shooter's gun, hand and trigger pull steady.

2. The system of targets as recited in claim 1, wherein the target sheet has a contrasting background provided outside of the at least one component, the contrasting background having a first color, such that when a shot is fired through the contrasting background there is instantaneous visual feedback to the shooter, the at least one component has a second color, which is different than the first color, such that when a shot is fired through the at least one component there is no instantaneous visual feedback to the shooter.

3. The system of targets as recited in claim 1, wherein width of the at least one component is proportional to the width of a front sight of the handgun.

4. The system of targets as recited in claim 3, wherein the width of the at least one component is 1.05 inches.

5. The system of targets as recited in claim 1, wherein the width of the at least one component is equal to width of front sight of handgun X distance of the target from the front sight/distance of front sight from eye of user.

6. The system of targets as recited in claim 3, wherein the at least one component of a respective target sheet of the progressive series of targets is a vertical linear component with linear edges, the linear relationship between the vertical linear component and the shooter's handgun sight provides vertical precision, improving the shooter's ability to keep the handgun from waving from side to side as the trigger is pulled.

7. The system of targets as recited in claim 3, wherein the at least one component of a respective target sheet of the progressive series of targets is a horizontal linear component with linear edges, the linear relationship between the horizontal linear component and the shooter's handgun sight provides horizontal precision, improving the shooter's ability to keep the handgun from moving up or down due to excess trigger pull or a short post shot follow through.

8. The system of targets as recited in claim 3, wherein the at least one component of a respective target sheet of the progressive series of targets is a cross component with linear edges having a vertical component and a horizontal component, the linear relationship between the cross component and the shooter's handgun sight helps the shooter focus on the middle of the cross component thereby improving calibration precision.

9. The system of targets as recited in claim 3, wherein the at least one component of a respective target sheet of the progressive series of targets is a solid box component with linear edges, the linear relationship between the solid box component and the shooter's handgun sight helps the shooter improve placement precision.

10. The system of targets as recited in claim 3, wherein the at least one component of a respective target sheet of the progressive series of targets includes a solid outline component with linear edges which surrounds a box component, the linear relationship between the solid outline component and the shooter's handgun sight helps the shooter improve draw precision.

11. The system of targets as recited in claim 3, wherein the at least one component of a respective target sheet of the progressive series of targets includes two vertical linear components with linear edges, the linear relationship between the two vertical linear components and the shooter's handgun sight helps the shooter improve re-acquisition precision of multiple targets.

12. The system of targets as recited in claim 3, wherein the at least one component of a respective target sheet of the progressive series of targets includes two horizontal linear components with linear edges, the linear relationship between the two horizontal linear components and the shooter's handgun sight helps the shooter improve re-acquisition precision of multiple targets.

13. The system of targets as recited in claim 3 5, wherein the at least one component of a respective target sheet of the progressive series of targets includes three vertical linear components with linear edges, the linear relationship between the three vertical linear components and the shooter's handgun sight helps the shooter improve multiple acquisition precision of multiple targets.

14. The system of targets as recited in claim 3, wherein the at least one component of a respective target sheet of the progressive series of targets includes three horizontal linear components with linear edges, the linear relationship between the three vertical horizontal components and the shooter's handgun sight helps the shooter improve multiple acquisition precision of multiple targets.

15. A system of handgun targets for increasing accuracy of a shooter, the system comprising:
a progressive series of linear targets which are_proportional to the width of a front sight of the handgun, the series of linear targets align with the sights of the handgun to improve a shooter's sight, trigger pull and muzzle direction, each target of the progressive series of targets comprising;
a first target sheet, the first target comprising:
at least one first component with first vertical linear edges, the first linear edges converge to create precise points of reference which provide a linear relationship to the sights of the handgun;
a second target sheet, the second target comprising:
at least one second component with second linear edges, the second linear edges converge to create precise points of reference which provide a linear relationship to the sights of the handgun.

16. The system of handgun targets as recited in claim 15, wherein the width of the at least one component is equal to width of front sight of handgun X distance of the target from the front sight/distance of front sight from eye of user.

17. The system of handgun targets as recited in claim 16, wherein the width of the at least one component is 1.05 inches.

18. A handgun target for improving the shooter's accuracy, the handgun target comprising:
at least one component with linear edges which is proportional to a front sight of the handgun, the linear edges converge creating precise points of reference which are configured to improve the accuracy of the shooter, the linear edges provide a linear relationship to the sight of the handgun,
wherein shots fired into the at least one component will not be visible to the shooter until the target is retrieved and shots fired which do not hit the at least one component will be visible to the shooter as the target sheet remains in position, thereby providing instantaneous visible feedback to the shooter with to allow for proper adjustment to facilitate the shooter to keep the shooter's gun, hand and trigger pull steady.

19. The handgun target as recited in claim 18, wherein the width of the at least one component is 1.05 inches.

20. The handgun target as recited in claim 18, wherein the width of the at least one component is equal to width of front sight of handgun X distance of the target from the front sight/distance of front sight from eye of user.
